(19) United States
(12) Patent Application Publication
(10) Pub. No.: US 2025/0290764 A1
(43) Pub. Date: Sep. 18, 2025

(54) Method and Apparatus for Requesting Predicted Routes from a Backend Server

(71) Applicant: Bayerische Motoren Werke Aktiengesellschaft, Muenchen (DE)

(72) Inventors: Stefan Holder, Muenchen (DE); Martin Wernwag, Garching (DE)

(21) Appl. No.: 18/861,138

(22) PCT Filed: Mar. 1, 2023
(86) PCT No.: PCT/EP2023/055163

§ 371 Date: Oct. 28, 2024

(30) Foreign Application Priority Data
May 16, 2022 (DE) 10 2022 112 167.4

(51) Int. Cl. G01C 21/36; G01C 21/34

(52) U.S. Cl. CPC G01C 21/3617; G01C 21/3484

(57) ABSTRACT

A method for requesting predicted routes from a backend server by means of a vehicle includes receiving a predicted route and a quantity of decision points for the predicted route from the backend server by the vehicle. The method also includes determining a traversal of a decision point from the quantity of decision points by the vehicle. A request is submitted to provide a further predicted route and a further quantity of decision points from the vehicle to the backend server after the vehicle has traversed the decision point. The method further includes receiving the further predicted route and the further quantity of decision points from the backend server by the vehicle.

The present application is the U.S. national phase of PCT Application PCT/EP2023/055163 filed on Mar. 1, 2023, which claims priority of German patent application No. 10 2022 112 167.4 filed on May 16, 2022, the entire contents of which are incorporated herein by reference.

### TECHNICAL FIELD

The disclosure relates generally to methods and apparatus for requesting predicted routes from a backend server using a vehicle.

### BACKGROUND

Current vehicles can request a predicted travel route from a backend server and provide the predicted travel route to a user of the vehicle. This may result in delays in providing the predicted route to the user of the vehicle.

There is a need, therefore, to provide predicted travel routes to a vehicle more efficiently. In particular, there is a need to request predicted travel routes faster and/or more flexibly from a backend server.

### SUMMARY

The above-described need, as well as others, is achieved by the features of at least some of the embodiments described herein.

A first embodiment is a method for requesting predicted routes from a backend server by means of a vehicle. The method can be a computer-implemented method and/or a control device-implemented method. The vehicle can be a land vehicle. For example, the vehicle can be a motor vehicle or a motorcycle. The backend server can be a server external to the vehicle, which is coupled to the vehicle via one or more communication channels. A predicted route can be a navigation route of the vehicle that is expected to be driven by a user of the vehicle. Preferably, a predicted route is a navigation route of the vehicle that the user of the vehicle is most likely to drive. The method involves receiving a predicted route and a quantity of decision points for the predicted route from the backend server by the vehicle. In addition, the method can receive a probability of the predicted route. In addition or alternatively, the method can receive multiple predicted routes and/or a quantity of decision points for the multiple predicted routes. If the method receives multiple predicted routes, the method can also receive a probability for each of the predicted routes. Furthermore, the method can additionally or alternatively transmit one or more predicted routes from the backend server to a mobile terminal. The mobile terminal can provide the one or more predicted routes to a user of the vehicle. The provision of a predicted route to a user of the mobile terminal and/or to a user of the vehicle can be carried out depending on the probability of a predicted route. If the probability of a predicted route exceeds a predetermined probability threshold, the method can provide the predicted route to the user.

The method can include determining whether the vehicle has traversed a decision point from the quantity of decision points. Furthermore, the method includes transmitting a request to provide another predicted route and a further quantity of decision points from the vehicle to the backend server after the vehicle has traversed the decision point. Finally, the method can receive the further predicted route and the further quantity of decision points from the backend server by means of the vehicle.

Advantageously, the method can dynamically request one or more predicted routes of the vehicle from a backend server depending on a traversal of a decision point. This means that the vehicle can automatically receive current predicted routes. The vehicle can thus efficiently control requesting predicted routes from a backend server. Unnecessary queries to the backend server can be efficiently avoided. Furthermore, the required data volume of a communication channel for requesting the predicted routes can be efficiently reduced. For example, the received predicted routes can be made available to a navigation system. The navigation system can thus automatically carry out destination guidance to the navigation destination by means of the provided routes using the received predicted routes.

According to some embodiments, a decision point can be a waypoint at which the routes taken by the vehicle branch off. This allows requesting the predicted routes to be efficiently controlled.

According to some embodiments, the quantity of decision points can be determined by the backend server depending on one or more historical trajectories of a user of the vehicle. This can be used to efficiently determine the quantity of decision points.

In addition, according to a further embodiment, an importance may be associated with each decision point, and/or the quantity of decision points may contain one or more decision points with importance exceeding a predetermined minimum importance threshold. The importance can be an importance value or an importance parameter. This allows the quantity of decision points to be determined efficiently. In particular, a number of decision points of the quantity of decision points can be determined efficiently. Adding unimportant decision points to the quantity of decision points can be efficiently prevented. Furthermore, unnecessarily transmitting unimportant decision points from the backend server to the vehicle can be avoided.

According to a further embodiment, the method may further include providing the predicted route as a navigation route suggestion to a user of f the vehicle, and/or providing the further predicted route as further a navigation route suggestion to the user of the vehicle, and/or activating navigation of the vehicle using the predicted route and/or the further predicted route in response to an operating input by the user of the vehicle to accept the navigation route suggestion and/or the further navigation route suggestion. This allows the predicted routes received by the vehicle to be processed efficiently. An inactive navigation system of the vehicle can be activated automatically by route guidance using a predicted route and/or can provide a suggestion for the activation of the route guidance by a user to the user of the vehicle.

According to a further embodiment, a decision point may be determined as having been traversed if the vehicle first enters a first predetermined circle around the decision point and then leaves a second predetermined circle around the decision point, wherein preferably a radius of the first circle is less than a radius of the second d circle, and wherein preferably the vehicle receives the radius of the first circle and the radius of the second circle for each decision point with the quantity of decision points received from the backend server. This allows the vehicle to efficiently detect the traversal of a decision point. Inaccuracies in determining the position of the vehicle can be efficiently avoided by using circles. Traversing decision points can be detected more reliably and/or precisely.

According to a further design, the method can include transmitting a time-controlled request to provide another predicted route and a further quantity of decision points from the vehicle to the backend server if a last request exceeds a specified time period and/or the method may include suppressing the time-controlled request to provide another predicted route and a further quantity of decision points from the vehicle to the backend server if a distance of the vehicle from a next decision point of the predicted route falls below a predetermined distance threshold and/or a time span to reach the next decision point falls below a predetermined time threshold. This can be used to efficiently control requesting decision points and/or one or more predicted routes.

A further aspect is characterized by a computer-readable medium for requesting predicted routes from a backend server by means of a vehicle, wherein the computer-readable medium contains instructions which carry out the method described above when executed by a computer or a control unit.

A further aspect is characterized by a system for requesting predicted routes from a backend server by means of a vehicle, wherein the system is designed to carry out the method described above.

Another aspect is characterized by a vehicle containing the system described above for requesting predicted routes from a backend server by means of a vehicle.

Further features result from the claims, the figures and the description of the figures. All the features and combinations of features above the mentioned in description as well as the features and combinations of features mentioned below in the description of the figures and/or shown in the figures alone can be used not only in the respective specified combination, but also in other combinations or on their own.

The above-described features and advantages, as well as others, will become more readily apparent to those of ordinary skill in the art by reference to the following detailed description and accompanying drawings.

### BRIEF DESCRIPTION OF THE DRAWINGS

FIG. 1 shows an exemplary method for requesting predicted routes from a backend server by means of a vehicle,

FIG. 2 shows an exemplary scenario for detecting a traversal of a decision point,

FIG. 3 shows a first scenario with predicted routes and decision points, and

FIG. 4 shows a second scenario with predicted routes and decision points.

### DETAILED DESCRIPTION

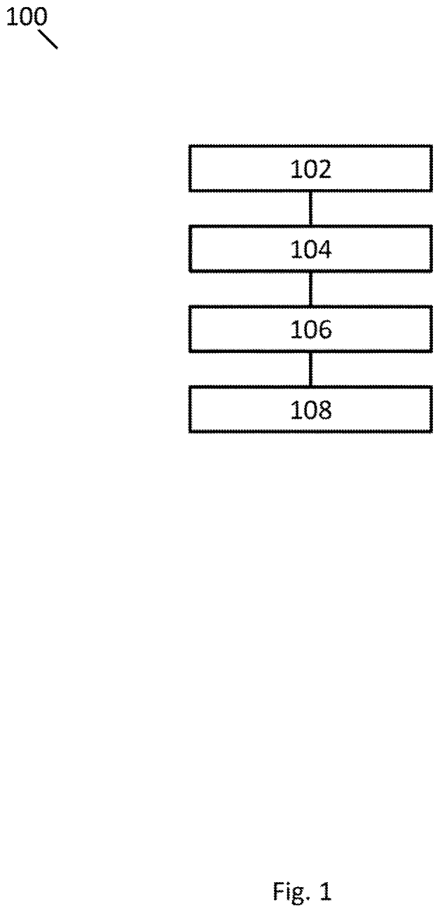

In detail, FIG. 1 shows an example method 100 for requesting predicted routes from a backend server by means of a vehicle. In detail, the method 100 can request predicted routes from a backend server if a user of the vehicle is not using a navigation system of the vehicle. After each journey with the vehicle, the vehicle can transmit a driven vehicle trajectory to the backend server. The vehicle trajectory can include a list of vehicle positions determined by a satellite-based navigation system. Furthermore, the vehicle can transmit a timestamp for a start of a journey, a timestamp for an end of a journey and/or a timestamp for each vehicle position to the backend server. The backend server can use a database of time information and/or historical route information of the vehicle to determine decision points and/or predict a route of the vehicle.

The method 100 can transmit a request, especially a request message, to provide a predicted route and a quantity of decision points from the vehicle to the backend server. For example, the request may be transmitted at the beginning of a journey and/or during the journey with the vehicle. The request can include a current vehicle position and/or a vehicle trajectory. For example, the vehicle trajectory may include a trajectory driven since the beginning of the journey and/or may include a predetermined number of positions, such as the last 1, 2, 3, 4, . . . , n positions, of the driven trajectory of the vehicle.

The method 100 can receive 102 one or more predicted routes, a probability for each predicted route, and/or a quantity of decision points for the one predicted route or the multiple predicted routes from the backend server by means of the vehicle. Preferably, the vehicle receives a predicted route, namely the most likely route for the vehicle. If the method 100 receives multiple predicted routes, the multiple predicted routes include the most likely route and one or more alternative routes to the most likely route. In addition, the backend server can transmit the one predicted route or the multiple predicted routes to a mobile terminal of one or more users of the vehicle. The mobile terminal can receive the one or multiple predicted routes and make them available to the user or users of the vehicle. This allows the method to automatically inform the user or users of the vehicle about the predicted route or the predicted routes.

The quantity of decision points can be determined by the backend server using historical driven routes. For example, from the historical driven routes of a user and/or a vehicle the backend server can determine positions for waypoints at which the historical driven routes branch off. A waypoint at which the historical driven routes branch off can be a decision point of the quantity of decision points. Furthermore, the backend server can calculate an importance, especially an importance value, for each decision point. The backend server can filter decision points using the importance. For example, the backend server can only add decision points that have a predetermined minimum importance to the quantity of decision points. In addition or alternatively, a maximum number of decision points can be specified for the quantity of decision points. If a maximum number of decision points for the quantity of decision points is specified, the decision points with the greatest importance can be determined up to the maximum number and added to the quantity of decision points.

The importance of a decision point preferably indicates the probability with which the most likely route changes when traversing the decision point. The following formula can be used for this:

$$P ( other destination after EP ) {\sum }_{i = 1}^{n} p ( {out\_path}_{i} ) \times important\_update ( {out\_path}_{i} ) =$$

wherein
p (out_pathi) is the conditional probability of leaving the decision point EP by the path out_pathi under the condition that the decision point EP has been reached; and important_update (out_pathi) is 1 if the most likely route changes after traversing the decision point via out_pathi, otherwise 0. A minimum probability of the most likely route, from which, for example, a navigation system of the vehicle is automatically started, is preferably taken into account. In this case, there is also an important change if the minimum probability is only achieved when traversing the decision point via out_pathi or if the minimum probability is no longer achieved after traversing the decision point via out_pathi.

Furthermore, the importance defined above of a decision point can be multiplied by the probability of reaching the decision point from the current vehicle position.

Alternatively, the importance of a decision point indicates the information gain to be expected from the decision point with respect to a predicted route. For example, the importance of the decision point can be calculated using an expected value of the information gain as follows:

$$E [ IG ( X ) ] = {\sum }_{d ∈ {D}_{X}} P ( d ) \cdot ( H ( R ) - H ( R \vert d ) ) ,$$

Wherein
X is a decision point;
IG the information gain;
Dₓ is a quantity of possible traversals of the decision point X; a pass d is defined by an incoming road segment and an outgoing road segment at a junction, such as an intersection or roundabout;
P (d): is the probability of a traversal d of the decision point X from the current vehicle position;
R: are route probabilities at the current vehicle position;
R|d: are route probabilities after the traversal d of the decision point X; and
H: is the entropy.

Here, the sum of the probabilities of all traversals of a decision point Σ_{d∈Dx} P (d) corresponds to the probability of traversing the decision point X from the current vehicle position in any way.

The backend server can also transmit a position for each decision point from the quantity of decision points to the vehicle. The vehicle can receive the position for each decision point with the quantity of decision points. Instead of calculating the importance of decision points and filtering decision points based on them, alternatively the following simple method can be used. Only predicted routes with probability exceeding a minimum probability of 0.1, for example, are taken into account when calculating decision points. Alternatively, only the most probable predicted routes up to a maximum number of routes are taken into account when calculating decision points. Both methods ensure that only the most important decision points are taken into account.

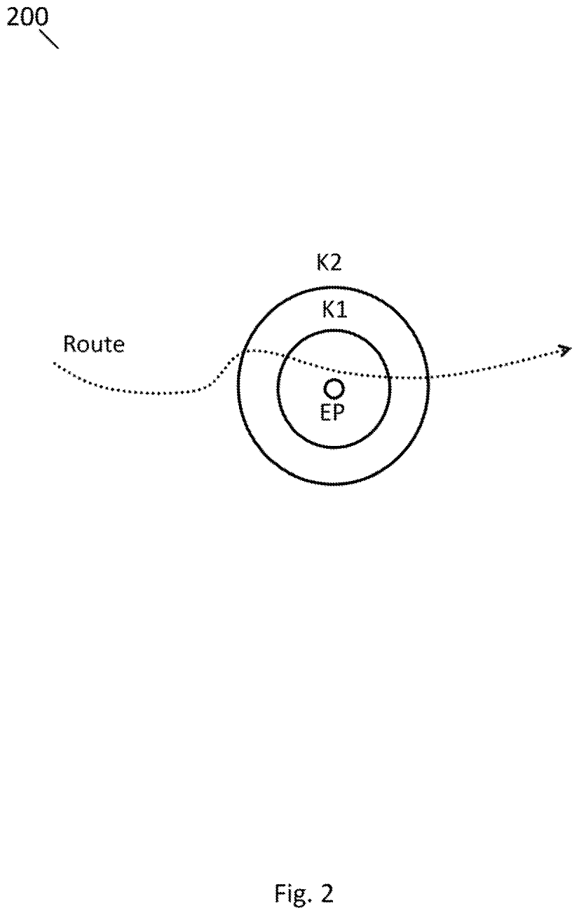

Furthermore, the method 100 can determine 104 whether the vehicle traverses a decision point from the quantity of decision points. In detail, FIG. 2 shows an example scenario 200 for determining a traversal of a decision point EP. A decision point EP can be considered to have been traversed in the present method 100 if the vehicle (not shown in FIG. 2) first enters a circle K1 along a route taken by the vehicle and then leaves a circle K2. The circle K1 and the circle K2 are preferably circles that have a decision point EP as their center. Furthermore, a radius of the circle K1 is smaller than a radius of the circle K2. For example, the radius of the circle K1 can be 90 m, and the radius of the circle K2 can be 100 m, for example. The radii of the circles K1 and K2 can be specified individually for each decision point. Alternatively, the radii of circles K1 and K2 can be the same for all decision points. The two circles K1 and K2 can represent a hysteresis function, which prevents entering a circle in the event of an inaccurate GNSS signal and mistakenly detecting a departure from the circle at a short time interval due to the inaccurate GNSS signal. Transmitting individual radii for each decision point can have the advantage that multiple decision points can be merged into one decision point with larger radii for the circles K1 and K2. For example, a number of decision points can be reduced by merging adjacent decision points into one decision point by increasing the radii of the circles K1 and K2 of a decision point.

Further, the method 100 can transmit 106 a request to provide another predicted route and another quantity of decision points from the vehicle to the backend server after the vehicle traverses the decision point. The method 100 can transmit a request to provide another predicted route and another quantity of decision points from the vehicle to the backend server after traversing each additional decision point from the quantity of decision points by the vehicle. The method 100 can cancel transmitting requests to provide another predicted route and another quantity of decision points from the vehicle to the backend server if a predetermined maximum number of requests to the backend server has been exceeded since the start of a journey with the vehicle and/or if a specified maximum time has elapsed since the start of the journey with the vehicle.

If the quantity of decision points includes a large number of decision points along one or more of the predicted routes of the vehicle, after each traversal of a decision point the vehicle can transmit a request from the vehicle to the backend server to provide another predicted route and another quantity of decision points. This can lead to frequent, unnecessary requests to the backend server from the vehicle, such as requests within a few seconds. To reduce the number of requests from the vehicle to the backend server, the number of decision points in the quantity of decision points can be reduced by the backend server by increasing the importance threshold and adding only decision points with an importance higher than the increased importance threshold to the quantity of decision points. In addition or alternatively, the vehicle can filter the decision points from the quantity of decision points according to their importance. For example, the vehicle may only transmit a request to the backend server if the importance of a decision point that has been traversed has a minimum predetermined importance.

Furthermore, the number of decision points can be reduced by only considering decision points at a maximum distance from the current vehicle position. Alternatively, decision points with the smallest distance from the current vehicle position can be determined up to a maximum number.

Furthermore, the number of requests after a traversal of decision points can be reduced by setting a predetermined, minimum time duration, for example 1, 2, 3, . . . min, between two requests from a vehicle to a backend server. Transmitting the request from the vehicle to the backend server is delayed until the specified minimum time duration from a previous request from the vehicle to the backend server is reached.

Furthermore, the method 100 can transmit a request to provide another predicted route and another quantity of decision points from the vehicle to the backend server if the vehicle deviates from a predicted route at a point at which there is no decision point in the quantity of decision points.

In addition, the method 100 can transmit one or more requests from the vehicle to the backend server to provide another predicted route and another quantity of decision points on a time-controlled basis. For example, the vehicle can transmit a request to the backend server on a time-controlled basis at cyclical intervals, for example every 10 minutes. A time-controlled request to provide another predicted route and another quantity of decision points from the vehicle has the advantage that even with a small number of decision points in the quantity of decision points, requests are regularly transmitted to the backend server, resulting in current predicted routes and current quantity of decision points being transmitted from the backend server to the vehicle. The vehicle can thus always receive up-to-date predicted routes and an up-to-date quantity of decision points from the backend server. The current predicted route can be provided to a user of the vehicle, a navigation system of the vehicle, and/or a mobile terminal of the user of the vehicle. The current quantity of decision points can be used to efficiently control a time for the further requests based on the decision points of the current quantity of decision points.

In addition, the method 100 can prevent one or more time-controlled requests before the vehicle traverses a decision point. The method 100 can prevent a time-controlled request from the vehicle to the backend server if the vehicle is closer than a specified distance, for example 1000 m, from a decision point. In addition or alternatively, the method 100 can prevent a time-controlled request from the vehicle to the backend server if an estimated time to reach a decision point is less than a specified threshold, for example less than 3 minutes. For example, to calculate the estimated time, a direct line or a route length from a current position of the vehicle to a decision point can be used to estimate how long the time to reach the decision point is expected to last.

By preventing one or more time-controlled requests, time-controlled requests from the vehicle to the backend server can be prevented for a longer period of time, for example 10, 20, 30, . . . , 50 min, even if no decision point is traversed by the vehicle. This can happen, for example, if there are a large number of decision points in the vicinity, i.e. within the specified distance to one or more decision points, of a route of the vehicle, which prevent one or more time-controlled requests from the vehicle to the backend server. The vehicle can transmit a time-controlled request from the vehicle to the backend server if a specified maximum time, for example 10 minutes, has elapsed since a last request from the vehicle to the backend server. This can result in preventing the vehicle from submitting a request from the vehicle to the backend server to provide another predicted route and another quantity of decision points for an extended period of time.

The method 100 can receive 108 the further predicted route and another quantity of decision points from the backend server by means of the vehicle. The vehicle may provide the predicted route and/or the further predicted route as a navigation route suggestion to the user of the vehicle. If the user accepts the navigation route suggestion, the navigation system of the vehicle can be activated using the navigation route suggestion.

Furthermore, the method 100 can provide one or more predicted routes and/or information, in particular route-relevant information, about one or more predicted routes to the user of the vehicle. This means that the user can be informed about route-relevant information even if the navigation system of the vehicle is not in use. For example, route-relevant information that can include an estimated travel time, an estimated time of arrival, a route length, and/or information about road closures, traffic reports and/or traffic jam reports along the predicted route(s) can be provided to the user of the vehicle. This means that the vehicle can provide the user of the vehicle with route-relevant information even if the navigation system is deactivated. The navigation system of the vehicle can use the predicted route to calculate one or more alternative routes to the predicted route. This allows the user to be quickly provided with alternative routes that will allow them to reach their destination faster than the predicted route. For example, the user of the vehicle can be informed by the vehicle of a delay on the predicted route with one or possible fast alternative routes. The user can start destination guidance of the navigation system on the predicted route or an alternative route to the predicted route by means of an operating input.

The backend server can predicate a route using known methods and determine a probability for the predicted route. The predicted route can be provided to the user of the vehicle if the probability for the predicted route is equal to or than greater a predetermined minimum probability. Predicted routes that have a probability that is less than the specified minimum probability will not be provided to the user of the vehicle. This can increase the user's acceptance of starting destination guidance of the navigation system using the predicted route. For example, at the beginning of the journey and/or for each new predicted route, the probability can be compared with the specified minimum probability. This ensures that changes in the probability of the predicted route are taken into account and that the predicted route is made available to the user of the vehicle in a timely manner.

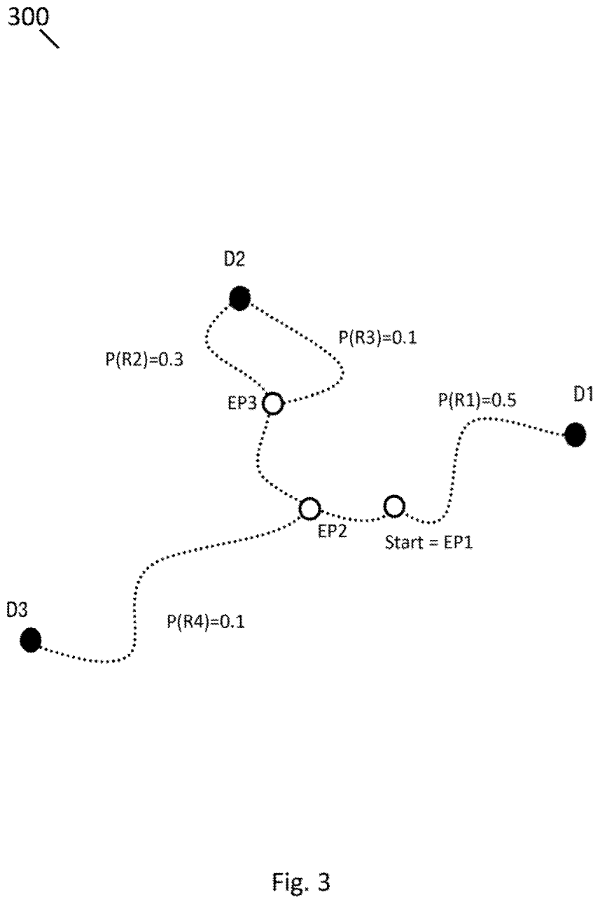

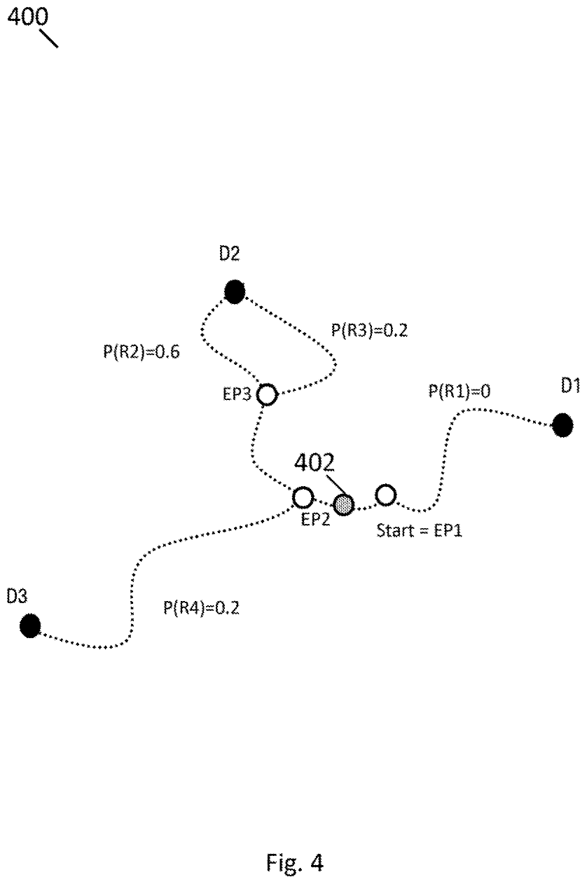

FIG. 3 shows a first scenario 300 with predicted routes and decision points at the beginning of a journey. FIG. 4 shows a second scenario 400 with predicted routes and decision points during the journey. Each of the scenarios 300 and 400 includes three navigation destinations D1, D2, and D3, four predicted routes R1, R2, R3, and R4, as well as three decision points EP1, EP2, and EP3. The vehicle starts the journey at decision point EP1. At the beginning of the journey, the probability P (R1) of route R1 is equal to 0.5, the probability P (R2) of route R2 is equal to 0.3, the probability P (R3) of route R3 is equal to 0.1 and the probability P (R4) of route R4 is equal to 0.1. The vehicle 402 is driving from EP1 towards EP2. The probability P (R1) of route R1 is now 0, the probability P (R2) of route R2 is equal to 0.6, the probability P (R3) of route R3 is equal to 0.2, and the probability P (R4) of route R4 is equal to 0.2. If the specified minimum probability for a predicted route is, for example, 0.6, no predicted route is displayed to the user in scenario 300, while in scenario 400 the predicted route R2 is provided to the user.

Advantageously, with the quantity of decision points the method can more efficiently determine a time for further requests to provide one or more additional predicted routes. A predicted route can thus be provided to a vehicle more quickly. Further, a number of requests can be efficiently controlled with the number of decision points in the quantity of decision points. With the decision points from the quantity of decision points the method can more efficiently control the number of requests from the vehicle to the backend server for predicted routes. This can efficiently improve a prediction of a route to a destination. The vehicle can provide a user with more precise route predictions. The user of the vehicle can receive information about the forecast or predicted route without a route guidance of the navigation system being activated by the user.

### LIST OF REFERENCE SIGNS

100 Method
102 Receiving a predicted route
104 Determining a traversal of a decision point
106 Submitting a request
108 Receiving another predicted route
200 Scenario
EP Decision point
K1 Circle
K2 Circle
300 Scenario
400 Scenario
402 Vehicle

1-10. (canceled)

11. A method for requesting predicted routes from a backend server by means of a vehicle, the method including:
receiving a predicted route and a quantity of decision points for the predicted route from the backend server by the vehicle;
determining a traversal of a decision point from the quantity of decision points by the vehicle;
submitting a request to provide a further predicted route and a further quantity of decision points from the vehicle to the backend server after the vehicle has traversed the decision point; and
receiving the further predicted route and the further quantity of decision points from the backend server by the vehicle.

12. The method as claimed in claim 11, wherein a decision point is a waypoint at which driven routes of the vehicle branch off.

13. The method as claimed in claim 12, wherein the quantity of decision points is determined by the backend server depending on one or more historical trajectories of a user of the vehicle.

14. The method as claimed in claim 11, wherein the quantity of decision points is determined by the backend server depending on one or more historical trajectories of a user of the vehicle.

15. The method as claimed in claim 11, wherein:
an importance is associated with each decision point; and
the quantity of decision points includes one or more decision points with an importance exceeding a predetermined minimum importance threshold.

16. The method as claimed in claim 11, further comprising:
providing the predicted route as a navigation route suggestion to a user of the vehicle.

17. The method as claimed in claim 16, further comprising:
activating a navigation of the vehicle using the predicted route or the further predicted route in response to an operating input of the user of the vehicle to accept the navigation route suggestion.

18. The method as claimed in claim 11, further comprising:
providing the further predicted route as a navigation route suggestion to a user of the vehicle.

19. The method as claimed in claim 11,
wherein determining the traversal of the decision point includes determining whether the vehicle first enters a first specified circle around the decision point and then leaves a second specified circle around the decision point; and
wherein a radius of the first specified circle is smaller than a radius of the second specified circle.

20. The method as claimed in claim 19, wherein the vehicle receives the radius of the first specified circle and the radius of the second specified circle for each decision point with the quantity of decision points from the backend server.

21. The method as claimed in claim 11, further comprising:
transmitting a time-controlled request for provision of the further predicted route and the further quantity of decision points from the vehicle to the backend server if a last request exceeds a specified period of time.

22. The method as claimed in claim 21, further comprising:
suppressing the time-controlled request to provide the further predicted route and the further quantity of decision points from the vehicle to the backend server if a distance of the vehicle from a next decision point of the predicted route falls below a predetermined distance threshold.

23. The method as claimed in claim 21, further comprising:
suppressing the time-controlled request to provide the further predicted route and the further quantity of decision points from the vehicle to the backend server if a time span to reach a next decision point falls below a predetermined time threshold.

24. The method as claimed in claim 21, further comprising:
providing the predicted route as a navigation route suggestion to a user of the vehicle.

25. The method as claimed in claim 24, further comprising:
activating a navigation of the vehicle using the predicted route or the further predicted route in response to an operating input of the user of the vehicle to accept the navigation route suggestion.

26. A non-transitory computer-readable medium for requesting predicted routes from a backend server by means of a vehicle, wherein the computer-readable medium contains instructions which, when executed by a computer or a control unit, carry out the method as claimed in claim 11.

27. A system for requesting predicted routes from a backend server by means of a vehicle, wherein the system is designed to carry out the method as claimed in claim 11.

28. A vehicle containing the system for requesting predicted routes from the backend server as claimed in claim 27.
